(19) United States
(12) Patent Application Publication
(10) Pub. No.: US 2006/0000816 A1
(43) Pub. Date: Jan. 5, 2006

(54) System for and method of zoom processing

(75) Inventor: Daniel Hogan, Acton, MA (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/882,092

(22) Filed: Jun. 30, 2004

(51) Int. Cl. B23K 26/06; B23K 26/38

(52) U.S. Cl. 219/121.75; 219/121.73; 219/121.77; 219/121.7

(57) ABSTRACT

A laser processing system for precision manufacturing is operated by adjusting a scan lens within the system to create a wide variety of features on a workpiece. The zoom scan lens is adjusted continuously within the system to alter radius of an annulus of the processing beam(s), resulting in change of feature size on the final workpiece. The zooming of the scan lens may be performed in combination with adjustments to the laser power and dwell time in order to maintain optimum power-per-unit area for high-quality laser processing. The invention is well-suited for drilling tapered, conical holes, such as those found in inkjet nozzles, but may be applicable for processing tapered or non-tapered features of almost any geometrical shape.

### FIELD OF THE INVENTION

The present invention relates to laser processing systems, and more specifically, to an improved system for and method of processing tapered or not-tapered features of almost any geometrical shape by using laser processing systems.

### BACKGROUND OF THE INVENTION

There is an ever-increasing demand for smaller electronic devices in today's high-tech marketplace. As a result, new and innovative fabrication techniques that are well-suited to small devices have become a focal point of many manufacturers. Manufacturers have turned to laser processing as a means of fabrication (e.g., for blowing fuses, via and hole drilling, ablation patterning, or resistor trimming). However, most laser processing systems are costly and inefficient. For example, single-feature laser processing systems process one feature (e.g., pattern, hole, or via) through ablative, additive, or transformational means at a time, and are, therefore, incapable of efficiently operating in large-volume manufacturing environments.

Exemplary products made with laser processing systems include inkjet nozzles, system LSI chips, printed circuit boards, etc. The market for replacement inkjet cartridges and inkjet nozzles is in the tens of millions of dollars ($USD) per year. With a market size of this magnitude, companies that create incremental cost savings in manufacturing can potentially realize millions of dollars of additional profit.

The hole shapes required in inkjet nozzles are generally conical and symmetrical. However, other shapes (e.g., pyramids, straight cylinders) can be imagined that may be useful in a variety of applications. Inkjet nozzles contain rows of holes (for example, 4 rows with 38 beams in each row) that are shaped in order to best project ink when they are used in an inkjet printer. These holes are drilled as specified with a tapered, conical shape, in which the input end of the hole is wider than the exit hole. The shape and measurements of the hole (input diameter, exit diameter, and taper) are critical to the product quality and the operation of the end application. For example, the taper of a drilled hole affects the fluid dynamics of ink in an inkjet printer nozzle. What is needed is a way to improve control of the resulting feature shape during laser processing. It should be noted that the definition of hole in the more general context can refer to the additive creation of shaped features to a workpiece or non-ablative transformation of the material properties (such as refractive index, transmissivity, etc.) of the workpiece.

Many laser-processing manufacturers have sought to reduce the cost of manufacturing by increasing yield. Increasing yield often requires higher optical power from the laser in order to reduce the processing time for each feature, thus increasing yield. This increase in optical power often has the negative effect of lowering the quality in the fabricated devices because of overexposure and thermal effects. Therefore, there exists a need to reduce cost by increasing manufacturing yield without sacrificing manufacturing quality. Likewise, there exists a need to increase manufacturing quality without sacrificing manufacturing yield.

In U.S. Pat. No. 6,627,844, entitled “Method of laser milling,” a method of milling is described whereby a single or parallel processing laser system is used to process a wide variety of complex shapes on a workpiece. The '844 patent describes a way to provide control of the processing beam(s) that allow(s) for almost any feature shape to be processed. However, the '844 patent requires the use of a scanning mirror, such as a galvanometer or PZT mirror, to direct the spot of the beam on the workpiece. The scanning mirrors used in the '844 patent are expensive to purchase and require frequent maintenance. Additionally, the milling algorithms described in the '844 patent take too much time to complete, which further decreases yield and increases the final cost of the finished product. What is needed is a less expensive way to manufacture workpieces that have a wide variety of specified shapes.

It is an object of this invention to provide a way to improve control of the resulting feature shape during laser processing.

It is another object of this invention to provide a way to reduce cost by increasing manufacturing yield without sacrificing manufacturing quality.

It is yet another object of this invention to provide a way to increase manufacturing quality without sacrificing manufacturing yield.

It is yet another object of this invention to provide a less expensive way to manufacture workpieces that have a wide variety of specified shapes.

### SUMMARY OF THE INVENTION

A laser processing system for precision manufacturing is operated by adjusting a scan lens within the system to create a wide variety of features on a workpiece. The zoom scan lens is adjusted continuously within the system to alter radius of an annulus of the processing beam(s), resulting in change of feature size on the final workpiece. The zooming of the scan lens is performed in combination with adjustments to the laser power and dwell time in order to maintain optimum power-per-unit area for high-quality laser processing. The invention is well-suited for drilling tapered, conical holes, such as those found in inkjet nozzles, but may be applicable for processing tapered or non-tapered features of almost any geometrical shape. Such processes include additive, ablative, or material transformation methods.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a laser processing system;

FIG. 2 illustrates an improved method of operating a laser processing system and maintaining optimum power-per-unit area for high-quality processing;

FIG. 3A shows an exemplary perspective view of a workpiece with conical workpiece features;

FIG. 3B shows an exemplary side view of a workpiece with conical workpiece features;

FIG. 4A shows an exemplary perspective view of a workpiece with pyramidal workpiece features;

FIG. 4B shows an exemplary side view of a workpiece with pyramidal workpiece features;

FIG. 5A shows an exemplary perspective view of a workpiece with arbitrary workpiece features;

FIG. 5B shows an exemplary side view of a workpiece with arbitrary workpiece features.

### DETAILED DESCRIPTION OF THE PREFERRED EMBODIMENTS

The following description of the preferred embodiment(s) is merely exemplary in nature and is in no way intended to limit the invention, its application, or uses.

The present invention includes a laser processing system for precision manufacturing and a method of using the system. More specifically, the invention includes a system for and method of laser zoom-processing to create a wide variety of features and feature shapes on the workpiece.

The present invention allows for faster processing of features and feature shapes on the workpiece by utilizing a larger beam diameter (relative to the overall feature size) and zooming in (processing a smaller and smaller area of the workpiece as it zooms) as the workpiece is processed to create the specified feature shape. This is a different processing method than is described in the '844 patent above, in which a smaller beam diameter (relative to the overall feature size) is utilized and directed by a scanning mirror (such as a PZT scan mirror, or a galvanometer), according to a milling algorithm, to process the workpiece in a stepwise fashion.

For illustration purposes, this invention will be described in the context of a parallel laser processing system. Parallel laser processing systems process more than one feature at once and often employ a beam splitter to divide the optical power into a plurality of sub-beams, which process the workpiece in parallel. The present invention also applies to single-feature processing; those familiar with the technical details of laser processing systems will be able to modify the invention to accommodate single-feature processing after reading the description below.

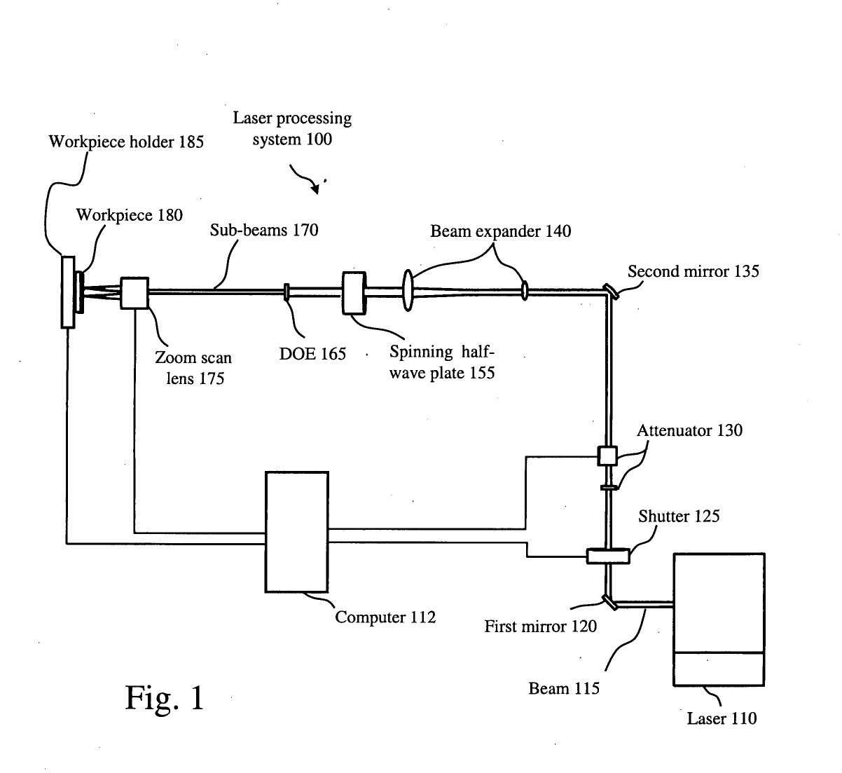

FIG. 1 illustrates a laser processing system 100, including the following elements: a laser 110, a computer 112, a beam 115, a first mirror 120, a shutter 125, an attenuator 130, a second mirror 135, a beam expander 140, a spinning half-wave plate 155, a DOE 165, a plurality of sub-beams 170, a zoom scan lens 175, a workpiece 180, and a workpiece holder 185, arranged as shown.

Laser 110 provides sufficient pulse energy to ablate material in workpiece 180. In one example, laser 110 is a picosecond (ps) laser (bandwidth less than 0.1 nanometer (nm)) that consists of an oscillator and a regenerative amplifier, for which the oscillator output power equals 35 milliwatts (mW), the pulse width is approximately 15 ps, the regenerative amplifier output power is 1 Watt (W) at 1 kilohertz (kHz), the energy per pulse is 1 millijoule (mJ), the power stability is 1.7% over 12 hours, and the pointing stability is approximately 1%.

Beam 115 is the pulse energy emitted by laser 110.

First mirror 120 and second mirror 135 are conventional mirrors used to direct or steer beam 115 along a specified path. It should be noted that the actual number of mirrors used to steer beam 115 may vary, depending the specific layout of the optical path of the drilling system.

Shutter 125 is a conventional mechanical shutter, such as those made by Vincent Associates (e.g., model # LS6ZMZ). The purpose of shutter 125 is to allow beam 115 to illuminate workpiece 180 when shutter 125 is in the open state and to prevent beam 115 from illuminating workpiece 180 when shutter 125 is in the closed state.

Computer 112 is one example of a controller that can be used in accordance with the present invention. Other types of controllers according tot he present invention are purely mechanical controls and/or an electromechanical control system. Preferably, the controller is computer 112, such as a personal computer, which can include conventional input devices (e.g., keyboard, mouse); output devices (e.g., monitor, printer, disk, etc); communication components (e.g., network card, serial ports); an operating system (e.g., Microsoft Windows, Linux); and software to convert product specifications into instructions for elements within laser processing system 100. As shown in FIG. 1, computer 112 has communication links to shutter 125, attenuator 130, zoom scan lens 175, and workpiece holder 185. Computer 112 coordinates the movements of one or more of these elements when processing complex features (such as shaped and tapered holes) in workpiece 180. In this example, computer 112 contains software applications capable of converting product, laser, and material specifications into processing algorithms required by laser processing system 100 in order for it to produce products that meet specifications. Computer 112 has access to lookup tables that contain historical data from various combinations of lasers, workpiece materials, and processing methods. It should be noted that the use of a computer is not necessarily required. In the case of a fixed line manufacturing system, an electromechanical system including elements such as gears, switches, etc. can be utilized to control the various essential elements of the laser processing system.

Attenuator 130 is a filter that continuously controls the energy outside laser 110. Attenuator 130, as shown in FIG. 1, includes a half-wave plate, such as those manufactured by CVI Laser (e.g., model # QWPO-1053-06-2-R10), followed by a polarizer, such as one manufactured by CVI (e.g., model # CPAS-10.0-670-1064).

Beam expander 140 is used in the present invention to match the spot size of beam 115 to the pupil size of zoom scan lens 175. The specifications of beam expander 140 are selected in coordination with the specifications of beam size of laser 110 and zoom scan lens 175. The laser beam size from beam expander 140 should be the same size or slightly smaller than the pupil size of zoom scan lens 175. One example of a beam expander is a pair of negative and positive lenses, with a focal length of −24.9 millimeters (mm) for the negative lens, and 143.2 mm for the positive lens.

Spinning half-wave plate 155 changes the polarization of beam 115 to increase the smoothness of the features in workpiece 180. In one example in which laser processing system 100 is drilling tapered holes in workpiece 180, such a change in polarization decreases rippling on the walls of the hole. In one embodiment, spinning half-wave plate 155 is a half-wave plate, such as those made by CVI Laser (e.g., model # QWPO-1053-06-2-R10), that spins at 600 revolutions per minute (RPM) and is driven by an electric motor.

DOE 165 is a compound diffractive optical element (DOE) that performs the functions of: (1) shaping beam 115 to create an annulus that will produce the specified feature shape on workpiece 180 and (2) splitting beam 115 to provide for parallel processing of workpiece 180. In another example, DOE 165 may be two DOEs that perform these two functions. In yet another example, DOE 165 may simply act as a beam shaper for creating one specified feature shape at a time. It should be noted that the word “annulus” in this description can not only mean a “circular shape with an inner and outer radius” but also an arbitrary shape whose perimeter thickness is defined by the focused laser beam or sub-beams and a size that can generically be described as a “radius” even though the shape is not circularly symmetric.

The pattern of sub-beams 170 output by DOE 165 is pre-determined by the product specifications. In one example, DOE 165 splits beam 115 into 152 beams in a pattern of 4 rows with 38 beams in each row.

Zoom scan lens 175 is a zooming scan lens that is able to adjust the annulus of sub-beams 170 at the point of contact with workpiece 180. Zoom scan lens 175 determines the spot size of sub-beams 170 upon workpiece 180. Zoom scan lens 175 is controlled by computer 112, which, when system 100 is in operation, adjusts the spot size of sub-beams as they impact workpiece 180 in order to create a wide variety of tapered features on workpiece 180. The combined size of sub-beams 170 as they enter zoom scan lens 175 must be less than or equal to the pupil size of zoom scan lens 175. Telecentricity is required to keep the incident angle between sub-beams 170 and workpiece 180 perpendicular, which is necessary to parallel process features in workpiece 180. In alternate embodiments for which the axes of the holes do not need to be parallel to each other, a non-telecentric scan lens can be used.

Workpiece 180 is the target of laser processing system 100. In one example, workpiece 180 is a stainless steel inkjet nozzle foil; however, the present invention may be generalized to a variety of workpiece materials, such as polymers, semiconductor metals, or ceramics. In alternate embodiments, laser processing system 100 can process features of a wide variety of shapes and tapers in workpiece 180.

Workpiece holder 185 is used in a laser drilling system to support workpiece 180 during laser drilling. Workpiece holder 185 is made of a hard, durable, stiff, and heat-resistant material (e.g., steel, aluminum, machinable ceramic, and the like). Workpiece holder 185 is generally attached to the stage in a laser drilling system with nuts and bolts or other similar attachment means. In one example, workpiece holder 185 is attached to a fixed stage. In other examples, workpiece holder 185 is attached to a stage that is moveable on a single axis such as an x-axis that alters position of the workpiece surface respective of the beam in an xy plane, a z-axis that alters length of the beam path by moving the xy plane in a z-direction orthogonal to the xy plane, a theta-axis that rotates the workpiece in the xy plane orthogonal to the beam path. In some embodiments, the beam path is orthogonal to the xy plane; in other embodiments the beam path is not orthogonal to the xy plane. Another single axis direction available in some embodiments is a phi-axis that rotates the xy plane about the x-axis, thereby controlling an angle of incidence between the xy plane and the beam path. Yet further embodiments have the workpiece holder 185 attached to a stage that is moveable on more than one axis, such as an xy stage, an xz stage, an x-theta stage, an x-phi stage, an xyz stage, an xyz-theta stage, an xyz-phi stage, or an xyz-theta-phi stage.

Movement on the z axis can occur based on an ablation or modification rate of workpiece material to control depth of ablation or modification. Zoom scan lens 175 can also be used to control depth of ablation based on the ablation rate of the material. The z-axis movement can be coordinated with the control of the zoom scan lens 175 to extend the range of this depth. Also, machining can be provided on a free-form basis in workpieces that are not flat. This capability is provided to some extent with zoom lens control, but adding the z-axis movement can extend the range of variation in the z-direction.

Movement of workpiece holder 185 can be coordinated with control of zoom scan lens 175, attenuator 130, and shutter 125 to accomplish an unprecedented range of shape control. For example, attenuator 130 can be used to control laser energy and shutter 125 can be used to control dwell time. Together, these two components can be controlled to keep the energy per unit area on the workpiece constant; which makes the amount of material being ablated or modified dependent on the area impinged by the shaped beam. Accordingly, zoom scan lens 175 and workpiece holder 185 can control depth of ablation or modification on the z axis based on the amount of area being impinged by the beam according to the known shape of the beam and the known shape of the workpiece. Also, it is possible to cause workpiece holder 185, and zoom scan lens 175, attenuator 130, and shutter 125 to be controlled as a function of a z axis input, a DOE selection input, a laser selection input, and a workpiece selection input, thereby greatly simplifying operation to achieve the wide variety of shapes.

In operation, laser 110 emits beam 115 along the optical path identified in FIG. 1 above. Beam 115 propagates along the optical path, where it is incident upon first mirror 120. First mirror 120 redirects beam 115 along the optical path, where it is incident upon shutter 125. To begin laser processing, computer 112 sends a signal to shutter 125 to open and illuminate workpiece 180. Beam 115 exits shutter 125 and propagates along the optical path to attenuator 130. Attenuator 130 filters the energy of laser 110 in order to precisely control ablation parameters. Beam 115 exits attenuator 130 and propagates along the optical path, where it is incident upon second mirror 135. Second mirror 135 redirects beam 115 along the optical path, where it is incident upon beam expander 140.

Beam expander 140 increases the size of beam 115. Beam 115 exits beam expander 140 and propagates along the optical path, where it is incident upon spinning half-wave plate 155. Spinning half-wave plate 155 changes the polarization of beam 115. Upon exiting spinning half-wave plate 155, beam 115 propagates along the optical path, where it is incident upon DOE 165.

DOE 165 performs two functions: 1) shaping beam 115 to create the annulus of light required to create specified features on workpiece 180; and 2) splitting beam 115 into a plurality of sub-beams 170, which allows parallel processing of workpiece 180. Sub-beams 170 exit DOE 165 and propagate along the optical path, where they are incident upon zoom scan lens 175. Zoom scan lens 175 determines the spot size of sub-beams 170 upon workpiece 180. As determined by laser processing algorithms, computer 112 sends signals to adjust the annulus of sub-beams 170 at the point of contact with workpiece 180. Sub-beams 170 exit zoom scan lens 175 and propagate along the optical path, where they are incident upon workpiece 180. Sub-beams 170 ablate workpiece 180, which is held in position by workpiece holder 185.

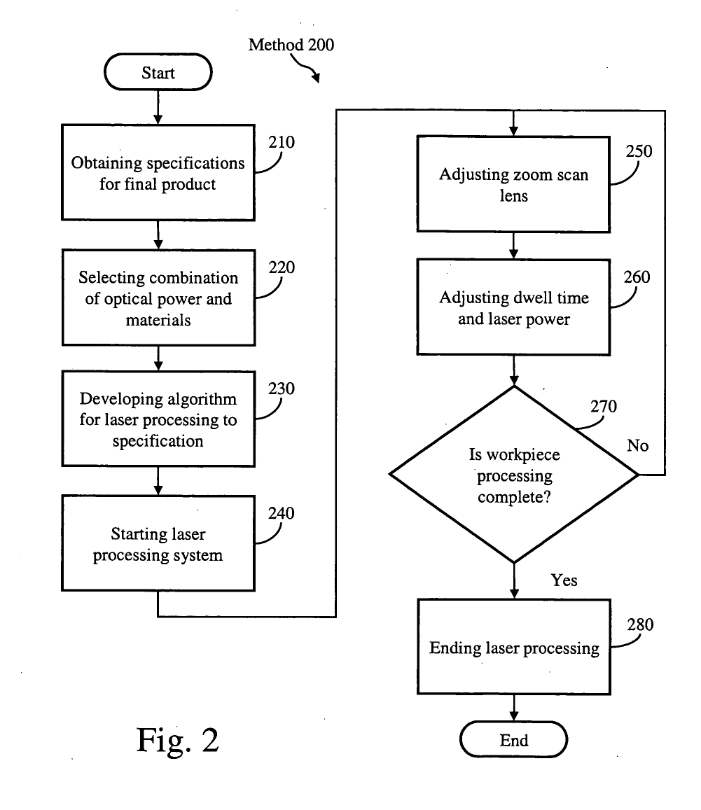

FIG. 2 shows an improved method 200 of operating a laser processing system and maintaining optimum power-per-unit area for high-quality processing.

All workpiece materials (e.g., polymers, metal foils, SiO2 substrates) have an optimum power-per-unit area for high-quality processing. Adjustments made by computer 112 include speed of zoom scan lens 175 and amount of laser power allowed to propagate through attenuator 130.

Method 200 includes the steps of:

Step 210: Obtaining specifications for final product

In this step, specifications for final product are analyzed and converted to a digital format. Specification details include feature shape and size, quality, materials, manufacturing cost, and the like. This specification is available to computer 112. In one example, the specification is stored on a disk within computer 112. In another example, computer 112 accesses the specification via a communication means, such as a network or the Internet. In one example, the specification is stored in a computer-aided design (CAD) file. In another example, the specification is stored in a database table similar to that shown in Table 1 below.

TABLE 1
Sample of specification data

| | Feature | | Melt | | | Pattern of |
|---|---|---|---|---|---|---|
| Material_name | shape? | Absorption? | Temp? | Size? | # of Features? | features? |
| SteelFoil1 | Cone | 1.88 × 10⁵ cm⁻¹ | 1535° C. | 20 μm | 500 | Regular |
| | | @ 1000 nm | | | | Grid |
| AlFoil2 | Polygon1 | 1.21 × 10⁶ cm⁻¹ | 660° C. | 40 μm | 200 | Linear |
| | | @ 1035 nm | | | | |
| PolymerFilm1 | Cylinder | 2.08 × 10⁶ cm⁻¹ | 110° C. | 80 μm | 2000 | Random |
| | | @ 632 nm | | | | |
| . . . | | . . . | . . . | | | |

Method 200 proceeds to step 220.

Step 220: Selecting combination of optical power and material

In this step, computer 112 determines the best combination of optical power and product material to meet product specifications from step 210. Examples of possible lasers include CW, nanosecond, picosecond, femtosecond, and others. Software operating on computer 112 reviews historical results that are stored in a database (not shown). Software operating on computer 112 selects the best combination of laser and processing method, based on historical data that shows results obtained when workpiece material selected in step 210 is used. In one example, computer 112 accesses a database (not shown) with product specification and results data for the available lasers and processing methods.

TABLE 2
Sample of laser characteristics data accessed by computer 112

| | Wave- | Pulse | | | Repetition |
|---|---|---|---|---|---|
| Laser_name | length | Energy | Pulse_width | Spot_size | Rate |
| Picosecond1 | 1053 nm | 1 mJ | 20 ps | 10 μm | 1 kHz |
| CW | 248 nm | n/a | n/a | 10 μm | continuous |
| Picosecond2 | 1064 nm | 10 mJ | 40 ps | 10 μm | 2 kHz |
| . . . | | . . . | . . . | . . . | |

Method 200 proceeds to step 230.

Step 230: Developing algorithm for laser processing to specification In this step, an algorithm is developed that combines the characteristics of the laser and materials to meet the product specification. This algorithm is used by computer 112 to direct how sub-beams 170 ablate workpiece 180. The algorithm is used by computer 112 to control shutter 125, attenuator 130, and zoom scan lens 175 and to produce the specified shape in workpiece 180.

TABLE 3
Sample of laser processing data accessed by computer 112

| Laser_Processing | Hole Shape | Pattern | Multi-step | Other? |
|---|---|---|---|---|
| Zoom Processing - | Cone | A1 | MS1 | . . . |
| Algorithm-ZP1 | | | | |
| Zoom Processing - | Polygon1 | A2 | MS2 | . . . |
| Algorithm-ZP2 | | | | |
| Zoom Processing - | Cylinder | A3 | MS3 | . . . |
| Algorithm-ZP3 | | | | |
| . . . | | | | |

Method 200 proceeds to step 240.

Step 240: Starting laser processing system

In this step, laser processing system 100 starts. Computer 112 sends a signal to shutter 125 to open. Processing of workpiece 180 begins. Method 200 proceeds to step 250.

Step 250: Adjusting zoom scan lens

In this step, zoom scan lens 175 is adjusted by computer 112 to set the radius of the annulus of sub-beams 170.

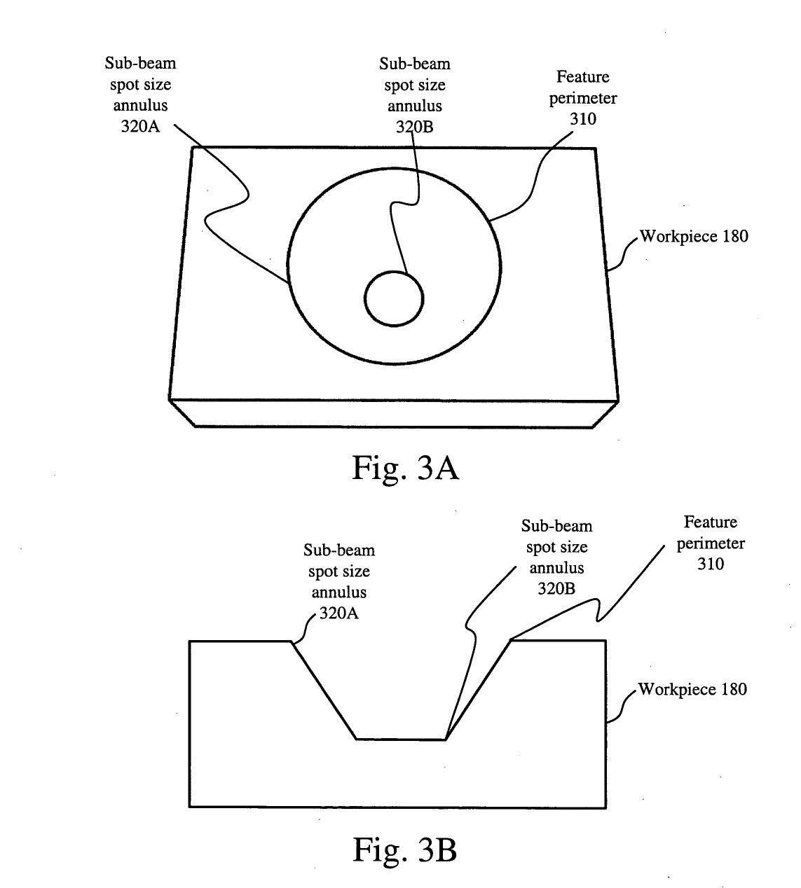

FIG. 3A shows an exemplary perspective view of workpiece 180 and further includes a circular feature perimeter 310 and a plurality of sub-beam spot size annuli 320.

FIG. 3B shows an exemplary side view of workpiece 180 and further includes circular feature perimeter 310 and the plurality of sub-beam spot size annuli 320.

The annuli of sub-beams 170 can initially be set to match the size of feature perimeter 310. In one example in which inkjet nozzle holes are being manufactured, zoom scan lens 175 is set to create sub-beam spot size annulus 320A (at its widest, at the beginning) and, as material in workpiece 180 is ablated, the annulus radius is decreased to sub-beam spot size annulus 320B, which decreases the radius of the hole created in workpiece 180 and eventually creates a conical hole, as shown in FIG. 3. Computer 112 continuously makes adjustments to zoom scan lens 175, based on the specifications of laser 110, workpiece 180, and the specifications determined in steps 210, 220, and 230 above. These continuous adjustments to zoom scan lens 175 result in smooth workpiece features, as shown in FIGS. 3A, and 3B. Method 200 proceeds to step 260. In another example, the location for starting the processing can be at any arbitrary point inside the perimeter of the annuli of the sub-beams. Additionally, processing can be bi-directional. For example, processing can be started at the center of the feature, moved out to the maximum of the perimeter and then swept back to remove another layer of material. For thick or hard materials it may be necessary to remove the material layer-by-layer in a similar way to that described in U.S. Pat. No. 6,627,844. However, in this case it is not necessary to move the beam but merely zoom in and out as each layer is removed.

Method 200 can be used to create features of almost any shape. Examples of possible feature shapes, not intended to be a complete list, are depicted in FIGS. 3A, 3B, 4A, 4B, 5A, and 5B.

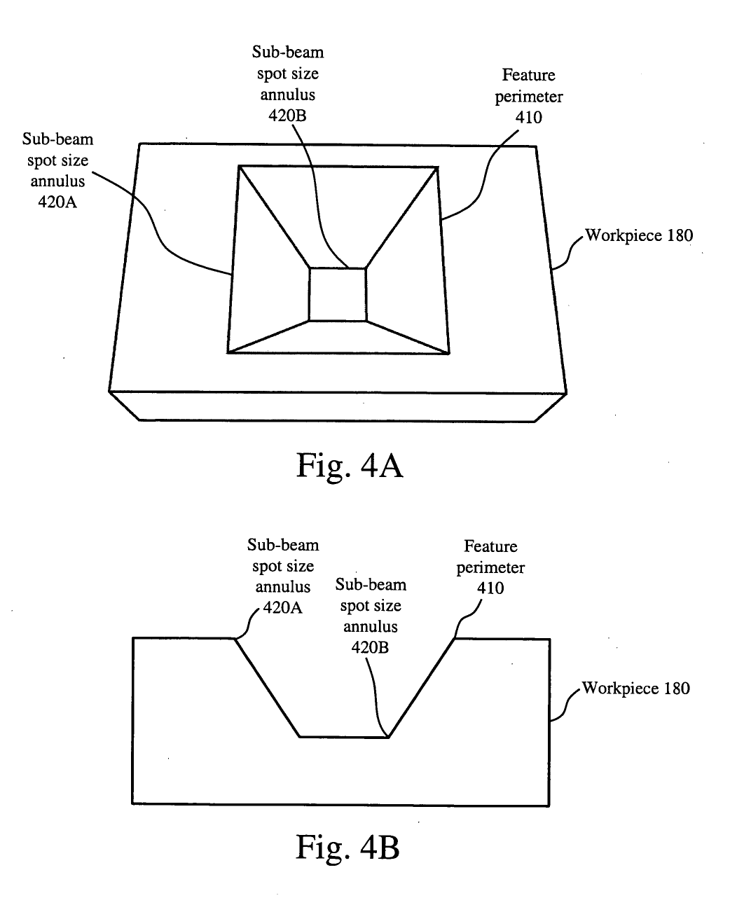

FIG. 4A shows an exemplary perspective view of workpiece 180 and further includes a pyramidal feature perimeter 410 and a plurality of sub-beam spot size annuli 420.

FIG. 4B shows an exemplary side view of workpiece 180 and further includes pyramidal feature perimeter 410 and the plurality of sub-beam spot size annuli 420.

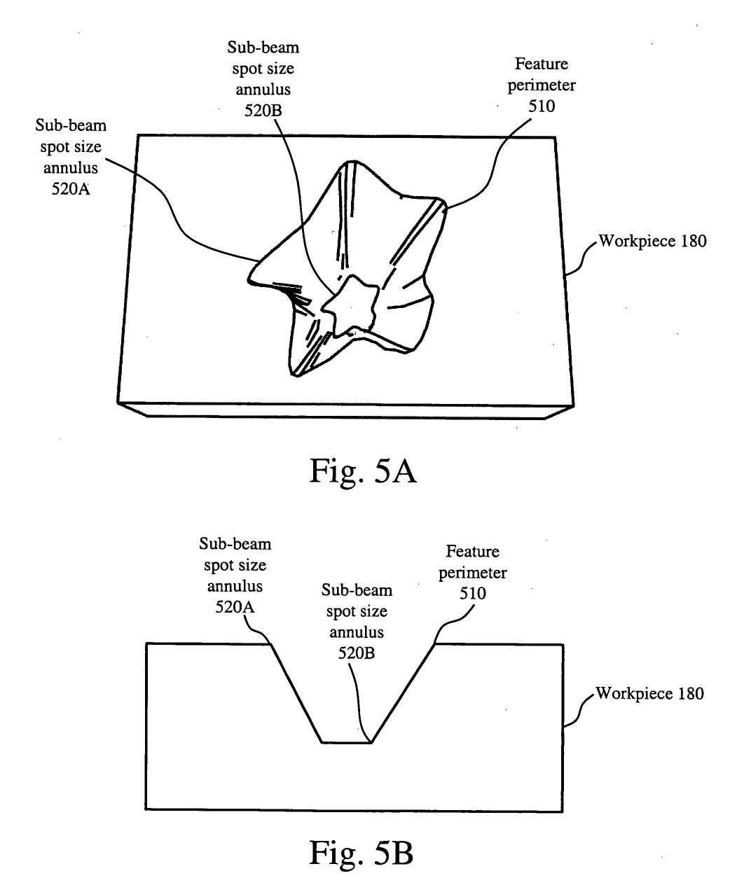

FIG. 5A shows an exemplary perspective view of workpiece 180 and further includes an arbitrary feature perimeter 510 and a plurality of sub-beam spot size annuli 520.

FIG. 5B shows an exemplary side view of workpiece 180 and further includes arbitrary feature perimeter 510 and the plurality of sub-beam spot size annuli 520.

Step 260: Adjusting dwell time and laser power

In this step, adjustments are performed to the dwell time and laser power simultaneously to counteract the effect of step 250 (which increases the energy per unit area), in order to maintain optimum laser power-per-unit area for high quality. By maintaining the optimum amount of power-per-unit area on workpiece 180, method 200 produces workpieces with improved quality features.

Within step 260, zoom scan lens 175 is adjusted by computer 112 such that the dwell time of sub-beams 170 incident upon workpiece 180 is adjusted to meet product specifications determined in steps 210, 220, and 230 above. Dwell time refers to the amount of time that sub-beams 170 are incident upon workpiece 180 (also known as the amount of time that sub-beams 170 dwell on the surface of workpiece 180). In one example in which laser processing system 100 is used to drill shaped holes, dwell time correlates to the amount of material abated from workpiece 180.

Also within this step, attenuator 130 is adjusted by computer 112 in order to adjust the power of beam 115 (and subsequently sub-beams 170) to meet product specifications that are determined in steps 210, 220, and 230 above. Computer 112 keeps the energy per unit area constant by attenuating laser power with attenuator 130.

Method 200 proceeds to step 270.

Step 270: Is workpiece processing complete?

In this decision step, computer 112 makes a determination if the processing algorithm is complete. If the workpiece processing is complete, method 200 continues on to step 280. If not, method 200 returns to step 240.

Step 280: Ending laser processing

In this step, computer 112 sends a signal to shutter 125 to close and laser processing ends. After this step, method 200 ends.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A laser processing system, comprising:
a laser providing a beam with sufficient pulse energy or average power to modify a workpiece;
a diffractive optical element (DOE) disposed to shape said beam to create a shaped beam capable of producing a specified feature shape on or in said workpiece;
a zoom scan lens disposed to adjust size of said shaped beam at point of contact with said workpiece by determining the size of said shaped beam on the surface of said workpiece; and
a controller operable to vary size of said shaped beam to obtain the specified feature shape on or in said workpiece.

2. The system of claim 1, in which said DOE is a compound DOE disposed to simultaneously shape said beam and split said beam into a plurality of shaped sub-beams to provide for parallel processing of said workpiece.

3. The system of claim 1, further comprising an additional DOE disposed to split said shaped beam into a plurality of shaped sub-beams to provide for parallel processing of said workpiece.

4. The system of claim 1, wherein said controller is operable to modify said workpiece layer-by-layer while changing the size of said shaped beam using said zoom scan lens.

5. The system of claim 1, further comprising an attenuator acting as a filter that can continuously control pulse energy or average power of said beam.

6. The system of claim 5, wherein said controller is operable to modify said workpiece by increasing or decreasing the pulse energy or laser power with said attenuator while simultaneously changing the size of said shaped beam using said zoom scan lens.

7. The system of claim 1, wherein said controller is a mechanical or electro-mechanical system or computer that controls rate of zoom of said zoom scan lens to create a wide variety of features on said workpiece.

8. The system of claim 6, wherein said controller is in communication with said attenuator and said zoom scan lens, operable to control said zoom scan lens to adjust the spot size of said shaped beam as it impacts said workpiece in order to create a wide variety of features on said workpiece, and operable to adjust dwell time and laser power during adjustment of the zoom scan lens to counteract change in energy per unit area applied to a surface of the workpiece.

9. The system of claim 8, wherein said controller is a computer which accesses a datastore recording historical data from various combinations of lasers, workpiece materials, and processing methods.

10. The system of claim 8, wherein said controller is a computer operable to run software capable of converting product specifications into instructions for elements within said laser processing system.

11. The system of claims 1, wherein said workpiece is a stainless steel inkjet nozzle foil, and said feature is a conical hole adapted for use as an inkjet nozzle.

12. The system of claims 1, further comprising a workpiece holder supporting said workpiece during laser processing, said workpiece holder made of a hard, durable, stiff, and heat-resistant material.

13. The system of claims 1, wherein said laser is a picosecond (ps) laser (bandwidth less than 0.1 nanometer (nm)) that includes an oscillator and a regenerative amplifier, for which the oscillator output power equals approximately 35 milliwatts (mW), the pulse width is approximately 15 ps, the regenerative amplifier output power is approximately 1 Watt (W) at 1 kilohertz (kHz), the energy per pulse is approximately 1 millijoule (mJ), the power stability is approximately 1.7% over 12 hours, and the pointing stability is approximately 1%.

14. The system of claim 1, further comprising a shutter controlling ablation of the workpiece by the laser according to instructions received from said controller.

15. The system of claim 1, further comprising a beam expander disposed to match a spot size of said beam to the pupil size of said zoom scan lens, said beam expander including a pair of negative and positive lenses, with a focal length of −24.9 millimeters (mm) for the negative lens, and 143.2 mm for the positive lens.

16. The system of claim 1, further comprising a spinning half-wave plate changing polarization of said beam to increase smoothness of features formed on or in said workpiece, said spinning half-wave plate spinning at least 600 revolutions per minute by an electric motor.

17. The system of claim 5, wherein said attenuator includes a half-wave plate followed by a polarizer.

18. A zoom processing method for use in a laser processing system for precision manufacturing, comprising:
laser processing a workpiece with a shaped beam; and
adjusting a zoom scan lens to vary size of said shaped beam during laser processing of the workpiece.

19. The method of claim 18, further comprising splitting said shaped beam into a plurality of sub-beams arranged in a pattern that meets the product specification.

20. The method of claim 18, further comprising adjusting dwell time and laser power during adjustment of the zoom scan lens to counteract change in energy per unit area applied by the beam to a surface of the workpiece.

21. The method of claim 18, wherein adjusting the zoom scan lens includes decreasing or increasing the size of said shaped beam as material in the workpiece is ablated, thereby decreasing or increasing size of a feature created in or on the workpiece and eventually creating a feature of a specified shape.

22. The method of claim 21, wherein adjusting the zoom scan lens includes initially setting the size of said shaped beam to match size of a feature perimeter.

23. The method of claim 21, wherein adjusting the zoom scan lens includes initially setting the size of said shaped beam to its minimum size.

24. The method of claim 21, wherein adjusting the size of said shaped beam includes continuously making adjustments to the zoom scan lens based on an algorithm developed to combine characteristics of a laser and materials to meet product specifications.

25. The method of claim 24, wherein continuously making adjustments to the zoom scan lens includes adjusting the zoom scan lens to obtain smooth workpiece features.

26. The method of claim 20, wherein adjusting dwell time and laser power includes performing adjustments to dwell time and laser power simultaneously to counteract change in energy per unit area resulting from adjustment of the zoom scan lens.

27. The method of claim 20, wherein adjusting dwell time includes adjusting an amount of time that the beam is incident upon a workpiece.

28. The method of claim 20, wherein adjusting dwell time includes adjusting an amount of material abated from a workpiece.

29. The method of claim 20, wherein adjusting laser power includes adjusting an attenuator in order to adjust the power of the beam to meet product specifications.

30. The method of claim 29, wherein adjusting laser power includes adjusting the attenuator in order to keep energy per unit area constant.

31. The method of claim 18, further comprising obtaining specifications for a final product.

32. The method of claim 31, wherein obtaining specifications includes analyzing the specifications and converting the specifications to digital format.

33. The method of claim 31, wherein obtaining specifications includes obtaining specifications having details relating to feature shape and size, quality, materials, and manufacturing cost.

34. The method of claim 18, further comprising selecting a combination of optical power and material based on specifications for a final product.

35. The method of claim 34, wherein selecting the combination of optical power and material includes selecting between CW, millisecond, microsecond, nanosecond, picosecond, and femtosecond lasers.

36. The method of claim 34, wherein selecting the combination of optical power and material includes reviewing historical data recording results obtained when workpiece material is combined with a laser.

37. The method of claim 36, wherein reviewing historical data includes accessing a datastore recording product specifications and results data for available lasers and processing methods.

38. The method of claim 18, further comprising developing an algorithm for laser processing to specification.

39. The method of claim 38, wherein developing the algorithm includes developing an algorithm that combines characteristics of a laser and materials to meet product specifications.

40. The method of claim 38, wherein developing the algorithm includes operating a computer according to the algorithm to direct how the beam of the laser processing system ablates the workpiece.

41. The method of claim 40, wherein operating the computer includes controlling a shutter, attenuator, and zoom scan lens to produce a specified shape in the workpiece.

42. The method of claim 18, further comprising starting the laser processing system by opening a shutter of the laser processing system.

43. The method of claim 42, further comprising determining whether workpiece processing is complete.

44. The method of claim 43, further comprising ending laser processing if workpiece processing is complete by closing a shutter of the laser processing system.

45. The method of claim 18, further comprising shaping the beam with a diffractive optical element.

46. The method of claim 45, further comprising employing a compound diffractive optical element to simultaneously shape the beam and split the beam into a plurality of shaped sub-beams suitable for parallel processing of the workpiece.

47. The method of claim 45, further comprising splitting the shaped beam into a plurality of shaped sub-beams suitable for parallel processing of the workpiece.
